(19) United States
(12) Patent Application Publication
(10) Pub. No.: US 2022/0000312 A1
(43) Pub. Date: Jan. 6, 2022

(54) PORTABLE COOKING APPARATUS

(71) Applicant: Wolf and Timber Inc., Kitchener (CA)

(72) Inventors: Steven Richard Motzkus, Del Mar, CA (US); George Atef Rizkalla, Cambridge (CA); Joseph Michael Hofer, Kitchener (CA)

(21) Appl. No.: 17/368,741

(22) Filed: Jul. 6, 2021

Related U.S. Application Data
(60) Provisional application No. 63/048,570, filed on Jul. 6, 2020.

(51) Int. Cl. A47J 37/10; A47J 27/04

(52) U.S. Cl. CPC A47J 37/108; A47J 2027/043; A47J 37/101; A47J 27/04

(57) ABSTRACT

A portable cooking apparatus including a frame, a grasping tool and a plurality of cooking implements is provided. The frame can transition between a planar configuration for use and a compact configuration for transport/storage. The frame can support one or more cooking implements simultaneously allowing for the separate cooking of foods at the same time using the same heat source. The plurality of cooking implements can be separated in an open configuration for use and are shaped to nest together in a compact configuration for storage/transport. The frame may be attached to a stand to vary the height of the height of the cooking implements above a heat source.

### TECHNICAL FIELD

The embodiments disclosed herein relate to portable cookware, and, in particular to a portable cooking apparatus that nests within itself to create a small form factor for transport and storage.

### INTRODUCTION

Existing portable cookware often include numerous parts that must be assembled/disassembled for use. This is time consuming and can lead to parts being lost. Portable cookware may also be large, heavy, bulky and difficult to transport and store easily.

Furthermore, existing portable cookware are not adjustable to vary the height of the cookware in relation to a heat source (e.g., a fire). Thus, a limitation of existing cookware is the inability to account for variations in heat/fire conditions and allow for different cooking techniques and the separate cooking of different foods, simultaneously, using the same portable cooking apparatus. Accordingly, there is a need for a portable cooking apparatus, that can be used to cook different foods separately, and allowing for different cooking techniques and that is robust, and easily portable and storable.

### SUMMARY

According to several aspects there are a plurality of portable cooking implements. The cooking implements may be used in an open configuration and collapsed into a compact nested configuration for transport/storage.

According to an aspect there is a portable cooking implement set, comprising: a first cooking implement having a first trough of a first depth, a first lip around the perimeter of the first trough and at least a first slit in the first lip, and a second cooking implement having a second trough of a depth less than the first depth, a second lip around the perimeter of the second trough and at least a second slit in the second lip, wherein the second cooking implement is placed atop the first cooking implement to securely retain at least a third cooking implement between the first cooking implement and the second cooking implement for transport/storage.

The at least third cooking implement has a third trough of a depth less than the first depth, a third lip around the perimeter of the third trough and at least a third slit in the third lip, wherein the third trough is nestable within the first trough when the third lip rests on the first lip. The set of cooking implements may further include a grasping tool for inserting into the slits to move the cooking implements. The set of cooking implements may be constructed of stainless steel, anodized aluminum or carbon steel.

According to another aspect, there is a portable frame for supporting cooking implements. The portable frame comprises a first rail and a second rail for supporting cooking implements, each rail having opposable ends; a pair of flexible metal wires attaching the respective opposable ends of the first rail to the opposable ends of the second rail; and four corner projections for removably attaching the portable frame to a stand, each corner projection extending from the opposable ends of each rail. The portable frame is convertible from a compact configuration to a substantially planar configuration upon attachment of the corner projections to the stand, wherein the first rail and the second rail are parallel to each other and perpendicular to the metal wires.

Each corner projection includes one or more metal stoppers for inserting into joints on the stand to removably attach the portable frame to the stand. The metal stoppers are disposed at increments along the length of each corner projection, the increments corresponding to fixable heights for the portable frame above a heat source. In the planar configuration, at least one cooking implement is supported by the first rail and the second rail and retained between the first rail, the second rail and the metal wires above a heat source. The at least one cooking implement may be moved along a length of the rails, between the metal wires, to vary the position of the cooking implement with respect to the heat source.

According to another aspect, there is a collapsible grasping tool. The grasping tool includes a first and second segment. The first and second segment may be used in an open configuration and removably attached to cooking implements as handles. The first and second segments may be used as cleaning/scraping tools to clean food residue from cooking implements or a grill. The first and second segments may be connected in a tongs configuration for grasping and manipulating hot objects. The first and second segments may be connected together in a nested configuration for transport/storage.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIGS. 1A-1B are perspective and top views, respectively, of portable cooking implements in an open configuration, according to one embodiment;

FIG. 1C is an exploded view of the portable cooking implements of FIG. 1A, in a nested configuration;

FIGS. 1D-1F are perspective, side and front views, respectively, of the portable cooking implements of FIG. 1C;

FIGS. 2A-2B are perspective and top views, respectively, of portable cooking implements in an open configuration, according to another embodiment;

FIGS. 2C-2D are exploded and perspective views, respectively, of the portable cooking implements of FIG. 2A, shown in a nested configuration;

FIG. 3A is a perspective view of a grasping tool in an open configuration, according to an embodiment;

FIG. 3B is a perspective view of a grasping tool in a tongs configuration, according to an embodiment;

FIGS. 3C-3D are perspective views of a grasping tool in a nested configuration, according to an embodiment;

FIG. 4A-4C are perspective, top and front views, respectively, of the grasping tool of FIG. 3A shown in relation to cooking implements, according to an embodiment;

FIG. 5A is a perspective view of a portable frame, according to an embodiment;

FIGS. 5B-5C are perspective and top views, respectively, of the portable frame of FIG. 5A, shown in relation to a stand;

FIGS. 6A-6B are perspective views of a portable cooking apparatus, according to several embodiments;

FIG. 6C is a side view of a portable cooking apparatus, according to an embodiment;

FIG. 6D is a perspective view of a portable cooking apparatus, according to an embodiment;

FIGS. 7A-7C are perspective views showing height adjustment of a portable cooking apparatus, shown in relation to a heat source, according to several embodiments;

FIG. 7D is a side view of the portable cooking apparatus shown in FIG. 7C.

FIG. 8A is a perspective view of a grasping tool according to an embodiment;

FIGS. 8B-8C are side and top views, respectively of the grasping tool of FIG. 8A shown grasping a cooking implement;

FIG. 9 is a perspective view of a lid handle, according to an embodiment;

FIG. 10A is an exploded view of region 250 of the portable frame in FIG. 5A;

FIG. 10B is the portable frame of FIG. 5A shown in a compact “crossed” configuration; and

FIG. 10C is the portable frame of FIG. 5A shown in a compact “figure 8” configuration.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

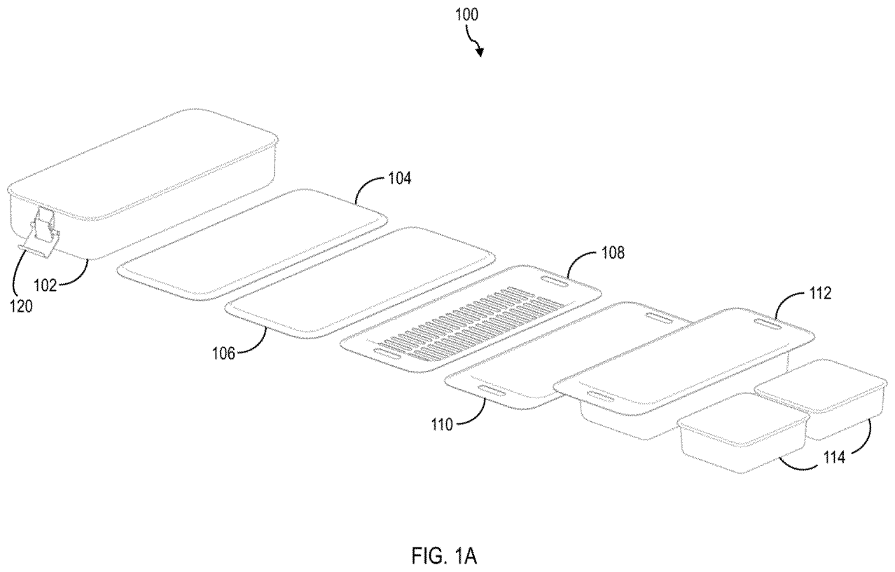

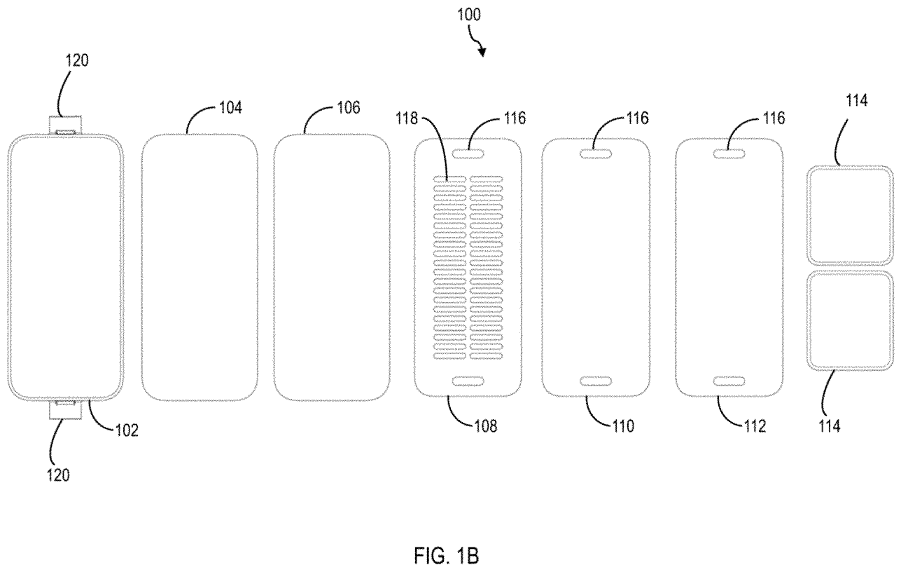

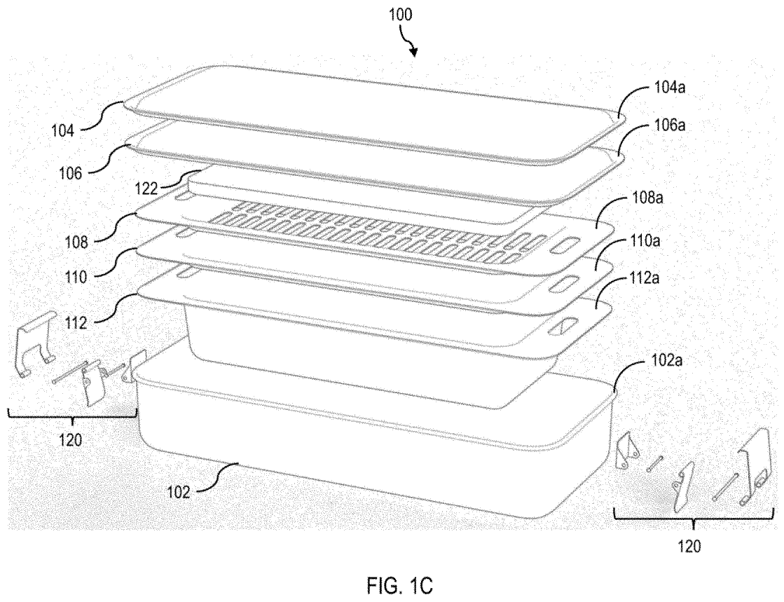

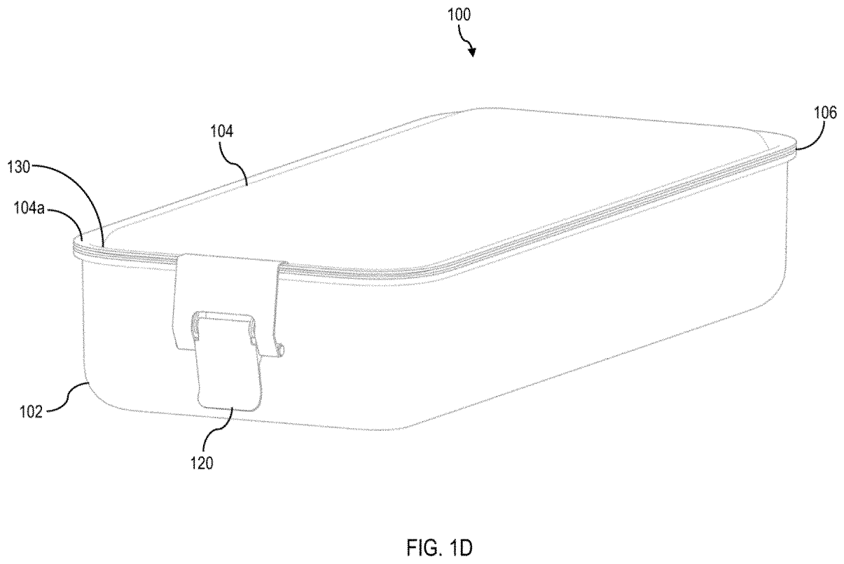

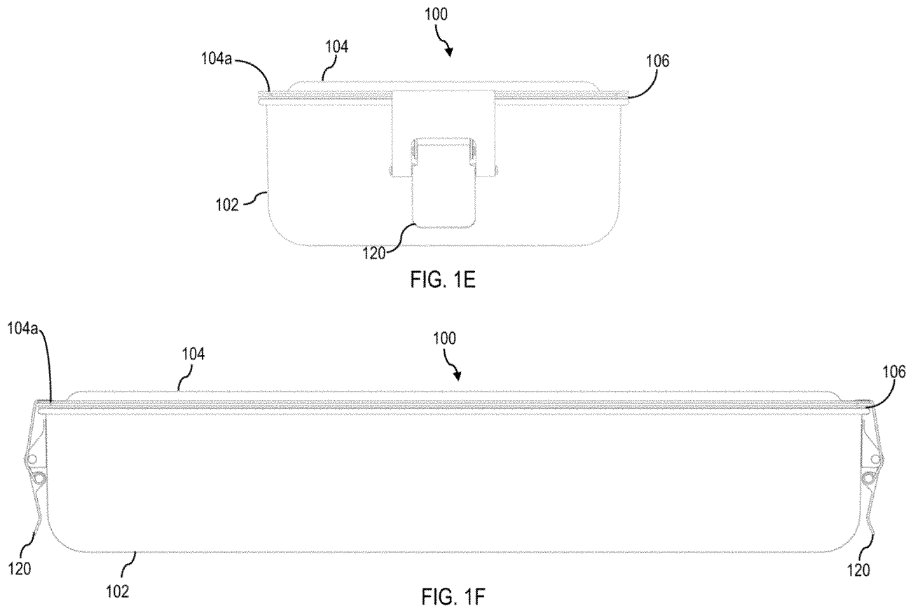

Referring to FIGS. 1A-1B, illustrated therein are a plurality of cooking implements 100 in an open configuration, according to an embodiment. The cooking implements 100 include a bottom 102, a lid 104, a plate 106, a hibachi pan 108, a fry pan 110 a boiler pan 112 and at least one bowl 114. The cooking implements 100 are preferably constructed of 304 stainless steel or hard anodized aluminum to be durable, heat resistant and light weight. According to an embodiment, the cooking implements 100 may be constructed of carbon steel. The metal construction of the cooking implements 100 allows for each cooking implement 102, 104, 106, 108, 110, 112, 114 to be used directly with a high temperature heat source (e.g., a fire) for cooking.

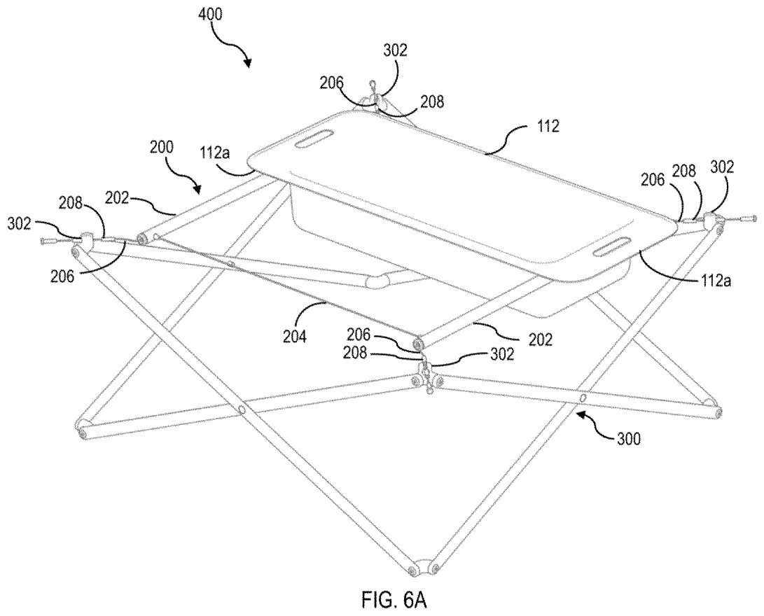

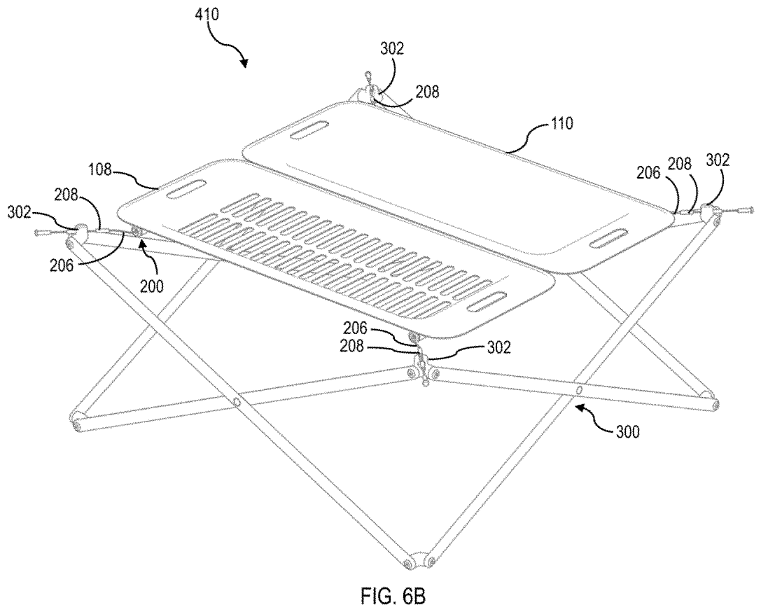

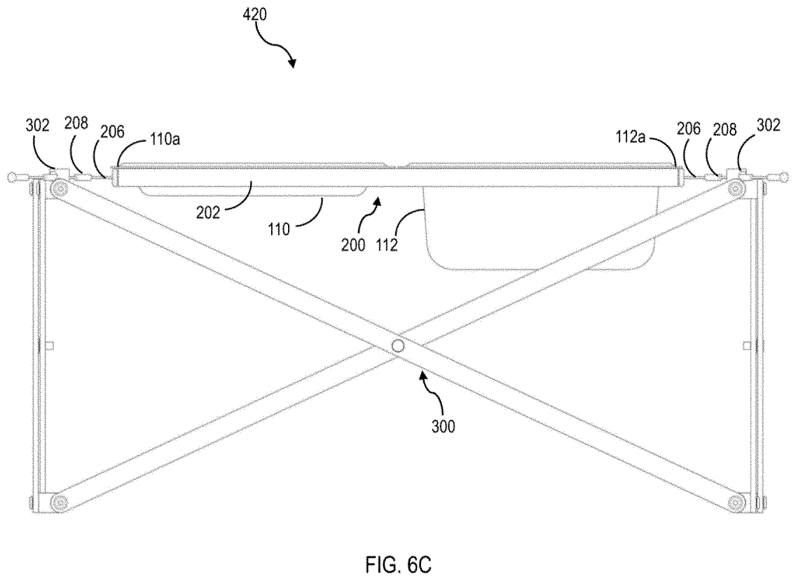

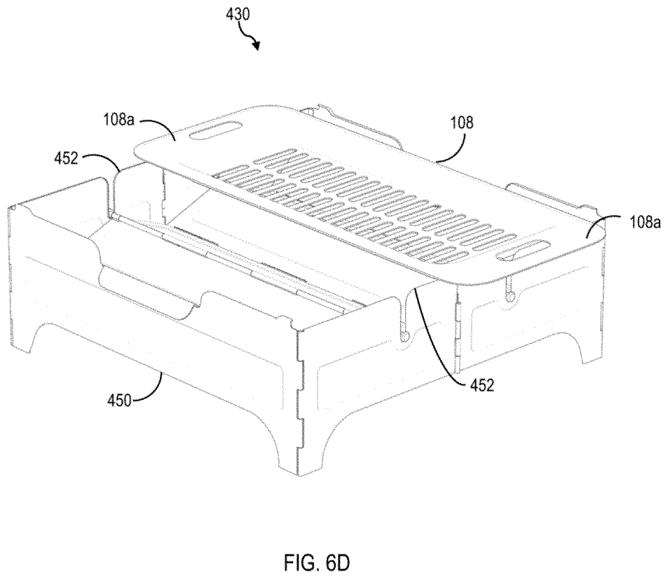

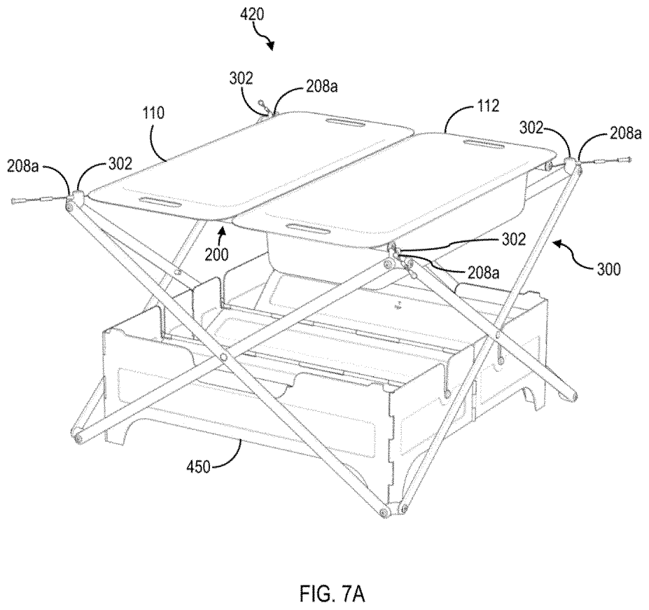

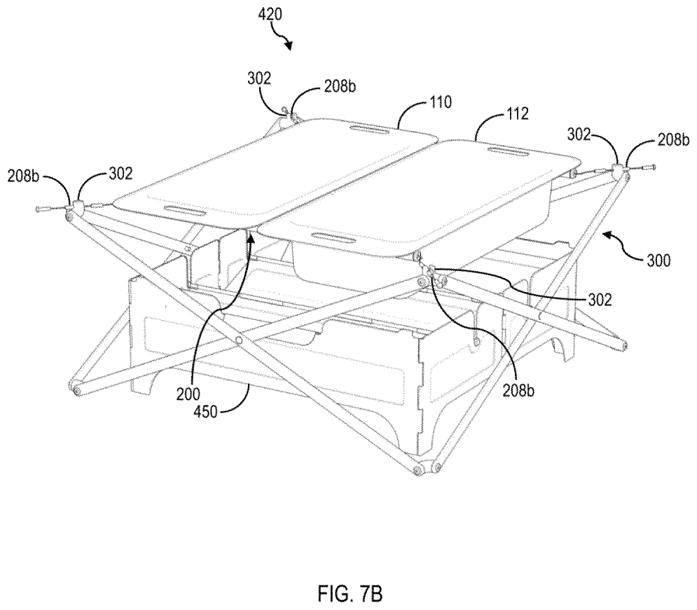

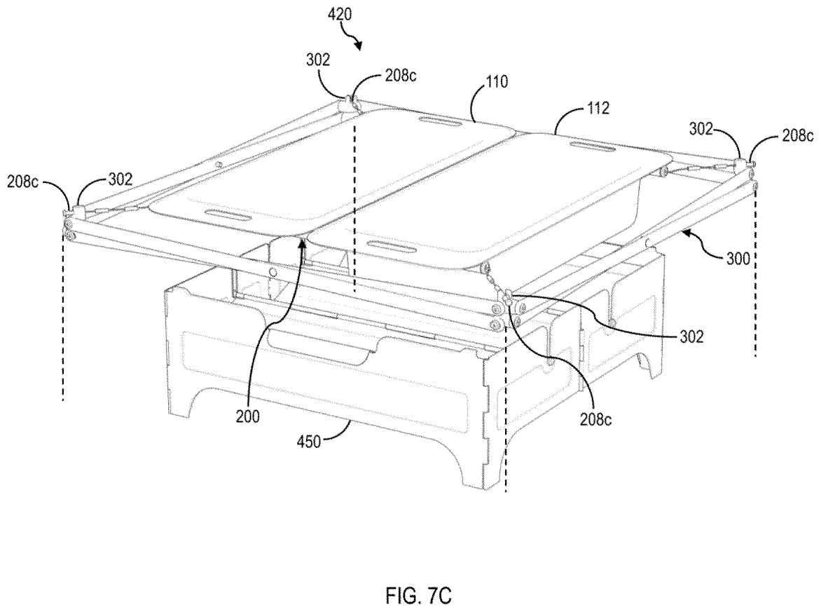

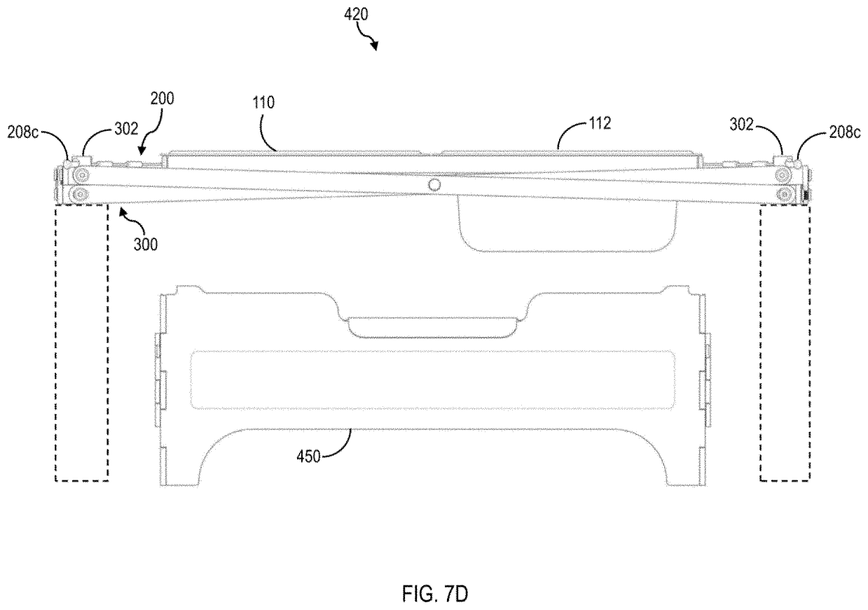

In the open configuration, the cooking implements 100 may be used individually, or used together, to prepare and cook food as described in detail below with reference to FIGS. 6A-7D. For example, the bottom pan 102, lid 104, plate 106, hibachi pan 108, fry pan 110 and boiler pan 112 may be used to cook or prepare solid food (e.g., meat, vegetables, etc.). The bottom pan 102 and boiler pan 112 are preferably used to cook or prepare liquids (e.g., soup, stew, boil water).

Each cooking implement 102, 104, 106, 108, 110, 112, 114 may be used alone or in combination with another cooking implement to prepare and cook food. The fry pan 110 is sized to cover the boil pan 112 and may be used as a lid to cover the boil pan 112. Similarly, the lid 104 or plate 106 may be used to cover the bottom pan 102. The hibachi pan 108 may be used to cover the boiler pan 112 for steam cooking (i.e. the steam generated from water boiling in the boiler pan 112, will rise through the grill surface 118 of the hibachi pan 108 to steam cook food placed on the hibachi pan 108).

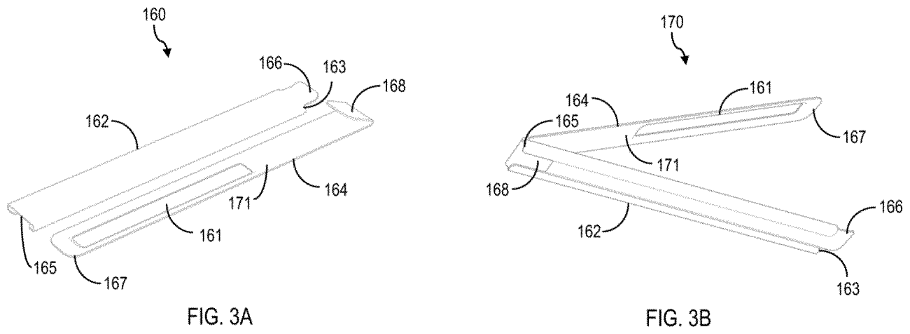

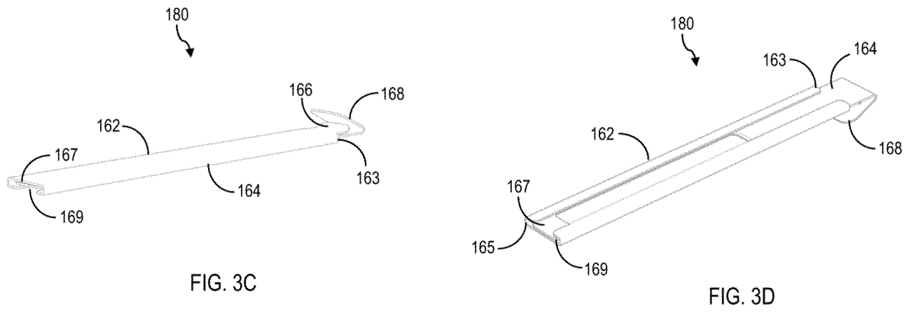

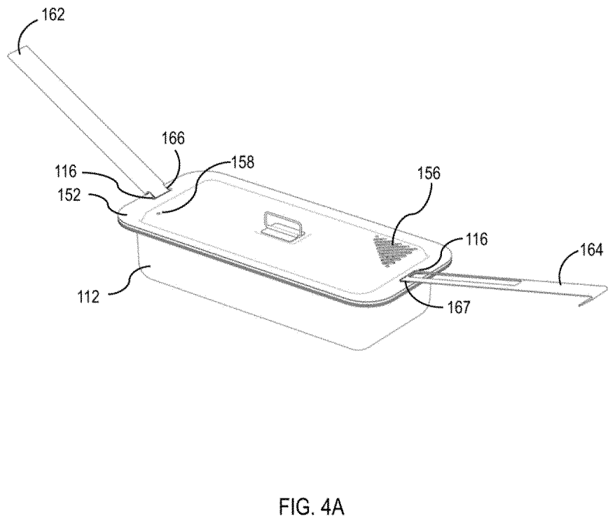

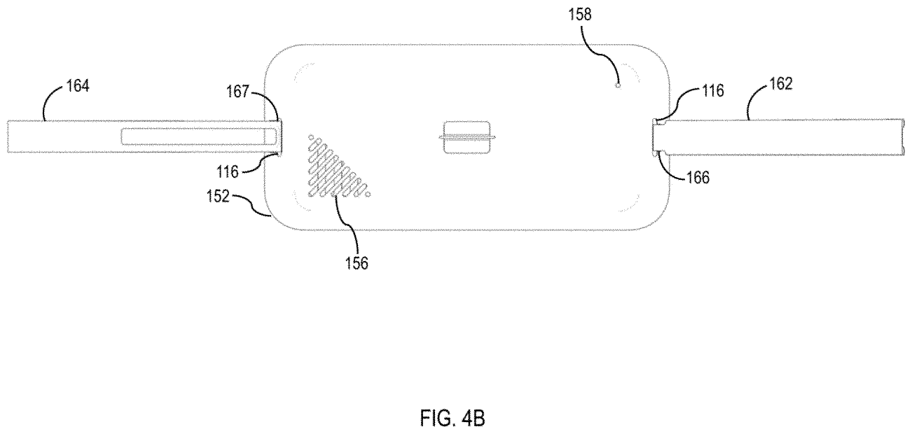

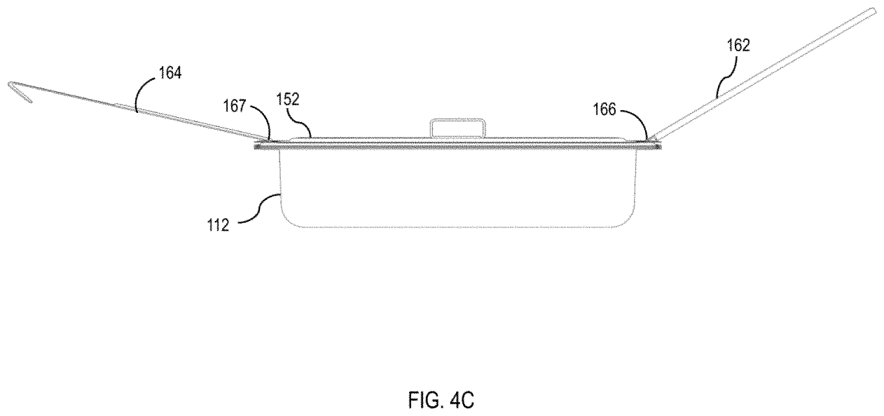

Now referring to FIG. 1B, the hibachi pan 108, the fry pan 110 and the boiler pan 112 each include two slits 116 (for ease of illustration one slit 116 is shown in each pan), for inserting a grasping tool (FIGS. 3A, 4A-4C) to lift/move the pan 108, 110, 112 when hot. The hibachi pan 108 includes a perforated surface 118 suitable for grilling. The lid 104 and plate 106 are identical and may be used interchangeably (i.e., the lid 104 may be used as a plate and the plate 106 may be used as a lid). The bottom 102 includes two latch clamps 120.

Referring to FIG. 1C, illustrated therein is an exploded view of the plurality of cooking implements 100 in a nested configuration, according to an embodiment. In the nested configuration, the bottom pan 102 and lid 104 form a container to house the plate 106, the hibachi pan 108, the fry pan 110 and the boiler pan 112.

The pans 102, 112, 110, 108 are trough-shaped to various depths in order to maximize the cooking surface area available in each pan 102, 110, 108, 112 while also allowing the pans to easily nest between the bottom pan 102 and the lid 104 in the nested configuration. For example, the bowls 114 (not shown) may nest within the boiler pan 108 when the implements 100 are in the nested configuration. The spaces between pans 102, 110, 108, 112 may be used to store a cutting board 122, a grasping tool (FIGS. 3C-3D), cleaning supplies, etc. that can be transported with the implements 100 in the nested configuration.

The boiler pan, 112, fry pan 110 and hibachi pan 108 each have an extended lip 108a, 110a, 112a around their perimeter, extending outward from the trough of each pan 108, 110, 112. The lip 108a, 110a, 112a supports the pan 108, 110, 112 on a portable frame (FIGS. 6A-6C), or on a portable fire pit 450 (e.g., FIG. 6D), or another object. Similarly, the bottom pan 102, the lid 104 and the plate 106 have perimeter lips 102a, 104a, 106a to align and support the cooking implements 102, 104, 106 in the nested configuration. In the nested configuration, the lip of a cooking implement 104, 106, 108, 110, 112 rest on the lip of the cooking implement directly below it. For example, as shown, the lip 110a of the fry pan 110 rests on the lip 112a of the boiler pan 112, which itself rests on the lip 102a of the bottom pan 102. While the cooking implements 100 are shown nested in a particular order, according to other embodiments, the cooking implements 100 may be nested in a different order. According to other embodiments, the cooking implements 100 may include more or fewer cooking implements 100 than shown.

Referring to FIGS. 1D-1F, illustrated therein are perspective, side and front view, respectively, of the cooking implements 100 in the nested configuration. The latch clamps 120 on the bottom pan 102 clamp to the lid 104 to lock the cooking implements 100 in the nested configuration, for storage or transport. The latch clamps 120 may clamp against the lip 104a of the lid 104 or engage a groove 130 in the lip 104a (see FIG. 1D). Compared to existing portable cookware, in the nested configuration, the implements 100 have a relatively small form factor, having dimensions of approximately 345 mm in length, 145 mm in width, and 60 mm in height.

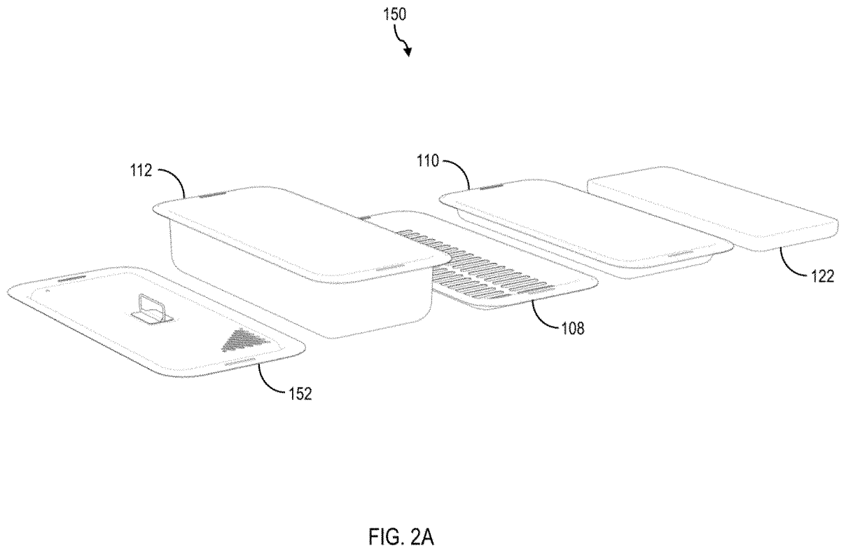

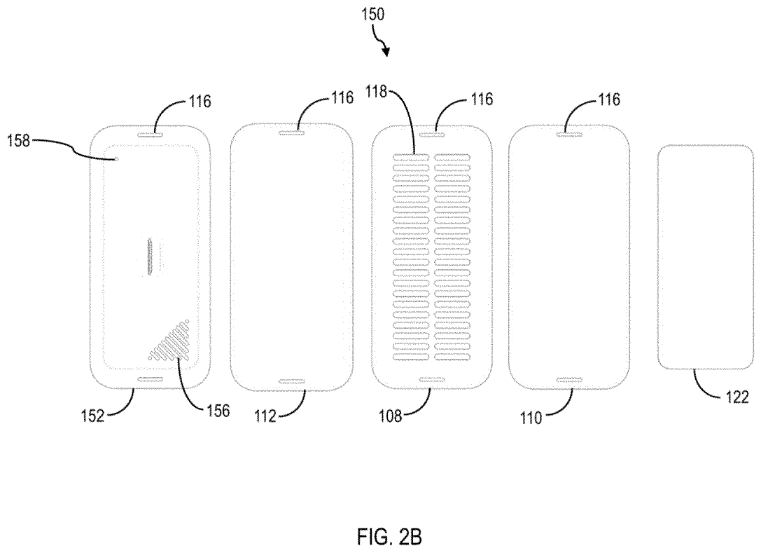

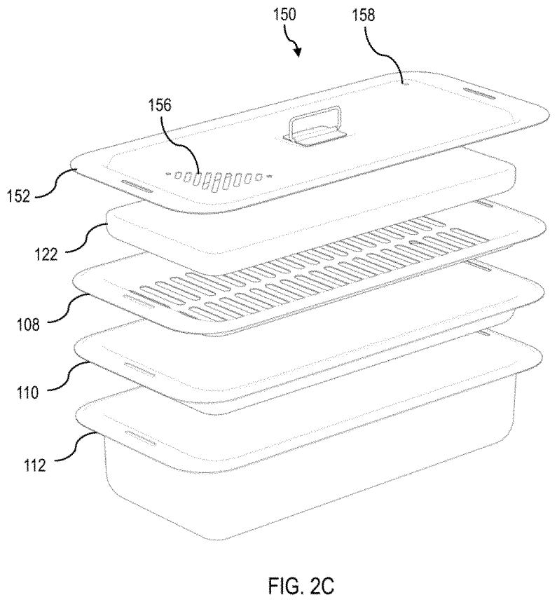

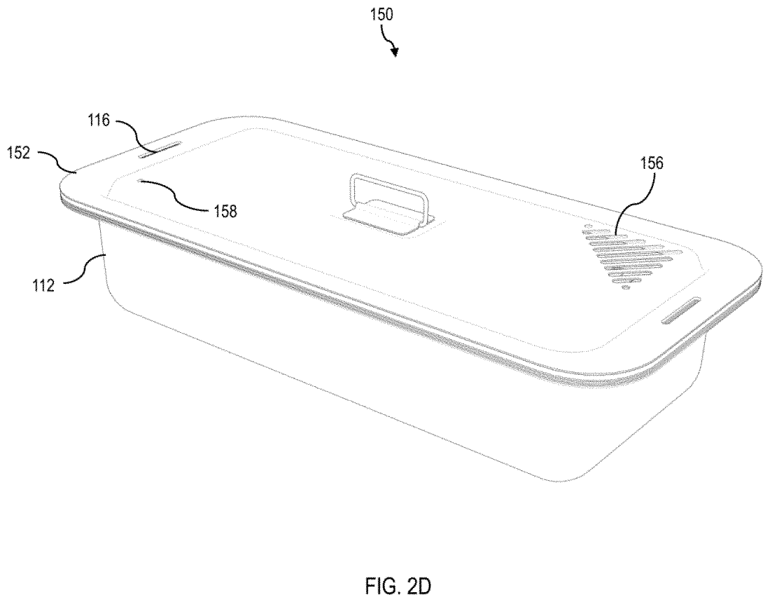

Referring to FIGS. 2A-2B, illustrated therein are a plurality of cooking implements 150 in an open configuration, in accordance with an embodiment. The cooking implements 150 includes the boiler pan 112, the hibachi pan 108, the fry pan 110 a perforated lid 152 and a cutting board 122.

The perforated lid 152 includes perforations 156, 158 to allow steam to escape when the lid 152 covers the boiler pan 112 during steam cooking. Perforations 156 also facilitates draining of excess liquid. The perforated lid 152 also includes two slits 116 (for ease of illustration one slit 116 is shown), for inserting a grasping tool (FIGS. 3A, 4A-4C) to lift/move the perforated lid 152 when hot.

Referring to FIG. 2C, illustrated therein is an exploded view of the plurality of cooking implements 150 in a nested configuration, according to an embodiment. In the nested configuration, the boiler pan 112 and the perforated lid 152 form a container to house the hibachi pan 108, the fry pan 110 and the cutting board 122.

Referring to FIG. 2D, illustrated therein is a perspective view of the cooking implements 150 in the nested configuration. The implements 150 have a relatively small form factor, having dimensions of approximately 338 mm in length, 141 mm in width, and 55 mm in height.

Referring to FIG. 3A, illustrated therein is a grasping tool 160 in an open configuration, according to an embodiment. The grasping tool 160 includes a first segment 162 and a second segment 164. In the open configuration, either the first segment 162 or second segment 164 may be used as a cleaning tool/scraper to clean food/cooking residue from a grill or cooking implements (i.e., cooking implements 100 or 150 in FIGS. 1A-2C. The first and second segments 162, 164 may be constructed of 304 stainless steel or hard anodized aluminum.

The first segment 162 includes a tab 166, a first opening 163 and a second opening 165. The second segment 164 includes a hook 168 and a first end 167 separated by a linear section 171. The hook 168 is bent at an acute angle with respect to the rest of the second segment 164 to allow the first segment 162 and the second segment 164 to be pivotably attached (FIG. 3B). The second segment 164 may include a cutout 161 in the linear section 171 to allow large/long objects (e.g., sticks, twigs) to protrude through when grasped with the tool 160.

Referring to FIG. 3B, illustrated therein is a grasping tool 170 in a tongs configuration. In the tongs configuration, the hook 168 of the second segment 164 is removably inserted into the second end 165 of the first segment 162. In the tongs configuration, the first segment 162 and second segment 164 are held together by the opposing forces exerted by a user's hand on the first segment 162 and second segment 164, respectively, when a user holds the grasping tool 170.

The grasping tool 170 may be used to grasp and hold (hot) objects between the tab 166 and first end 167 in a clamp-like manner. For example, the grasping tool 170 may be used to grasp or manipulate hot embers, charcoal, firewood hot food, or hot cooking implements.

Referring to FIGS. 3C-3D, illustrated therein are perspective views of a grasping tool 180 in a nested configuration, according to an embodiment. In the nested configuration, the second segment 164 fits within a channel 169 in the first segment 162 by passing the first end 167 of the second segment 164 between the first opening 163 and second opening 165 of the first segment 162 until the tab 166 is adjacent to the hook 168. In this way, the first segment 162 acts as a sheath for the second segment 164 when the grasping tool is in the nested configuration.

The grasping tool may my transported or stored in the nested configuration. The grasping tool 180, in the nested configuration, may be small enough to fit into spaces between cooking implements (i.e., cooking implements 100 or 150 in nested configurations shown in FIGS. 1C-1F and 2C-2D) during transport or storage of the cooking implements.

Referring to FIGS. 4A-4C, illustrated therein are perspective, top and front views of the grasping tool in an open configuration (i.e. the first segment 162 and the second segment 164) shown in relation to hot cooking implements (i.e. boiler pan 112 and perforated lid 152). The tab 166 of the first segment 162 and the first end 168 of the second segment 164 are inserted into the slits 116 in the boiler pan 112 and/or perforated lid 152. This allows for the first and second segments 162, 164 to function as removable handles for the boiler pan 112 and/or perforated lid 152 (or any cooking implement having slits 116). The boiler pan 112 and/or perforated lid 152 may then be moved by holding the first and/or second segments 162, 164. Thus, the cool handles can be attached when needed to move hot cooking implements, without having to touch the implements themselves.

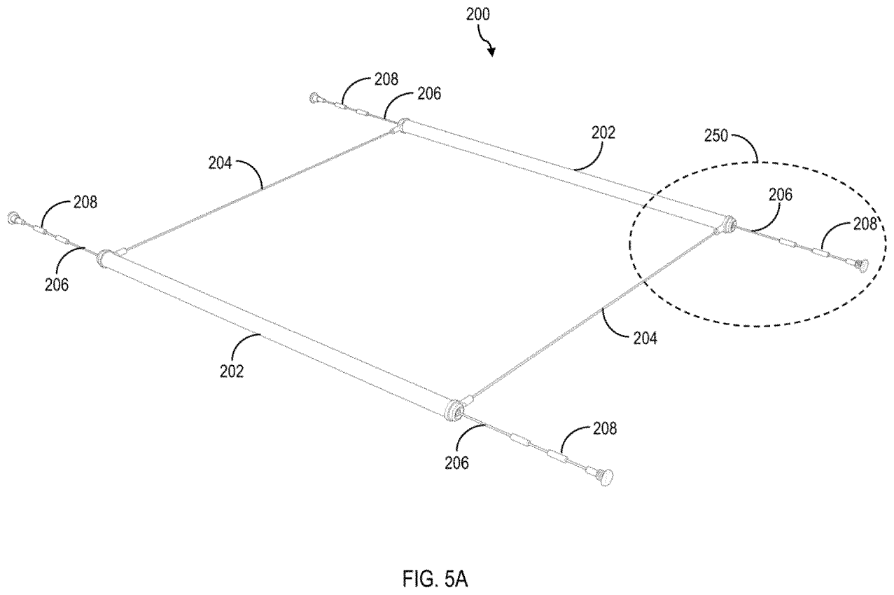

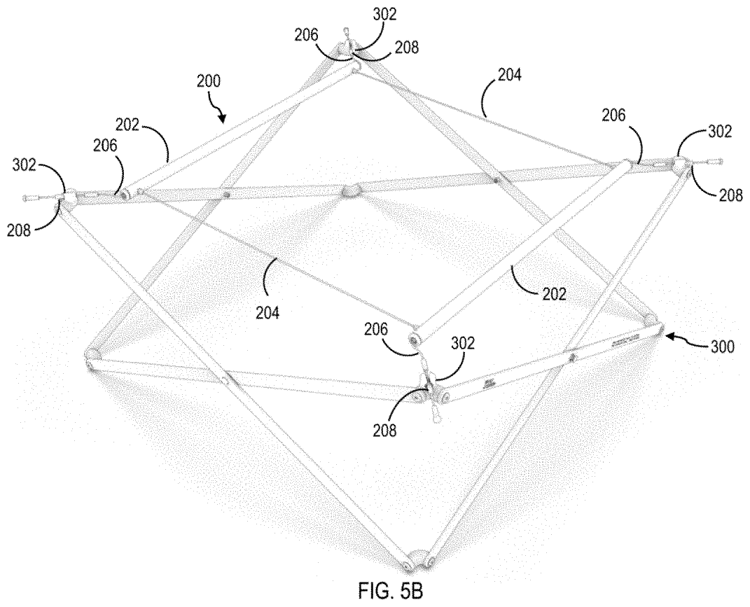

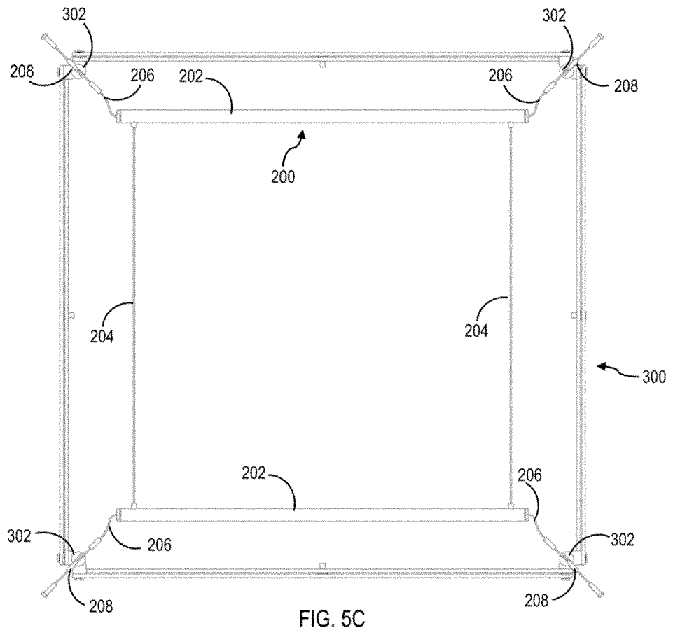

Referring to FIG. 5A, illustrated therein is a perspective view of a portable frame 200 for supporting cooking implements, in accordance with an embodiment. The frame 200 includes a pair of parallel rails 202 connected by a pair of flexible metal wires 204. This arrangement allows the frame 200 to transition from a substantially square planar configuration, for use (as shown), and collapse into a compact state for transport or storage.

According to an embodiment, the metal wires 204 may withdraw into the rails when the frame 200 is collapsed. According to an embodiment, the wires 204 may be elastic or spring biased to hold the rails 202 together (in the compact state). The frame 200, may optionally include a brace (not shown), for holding apart the metal rails 202, thereby straightening the metal wires 204 and bracing the frame 200 in the planar configuration.

According to an embodiment, the frame 200 may be formed by parallel rails 202 joined by folding scissor arms, wherein the arms are straightened in the planar configuration and bent in the collapsed state. According to an embodiment, the frame 200 may be a folding unibody frame having a center hinge between two spaces for inserting cooking implements into the frame either side of the hinge.

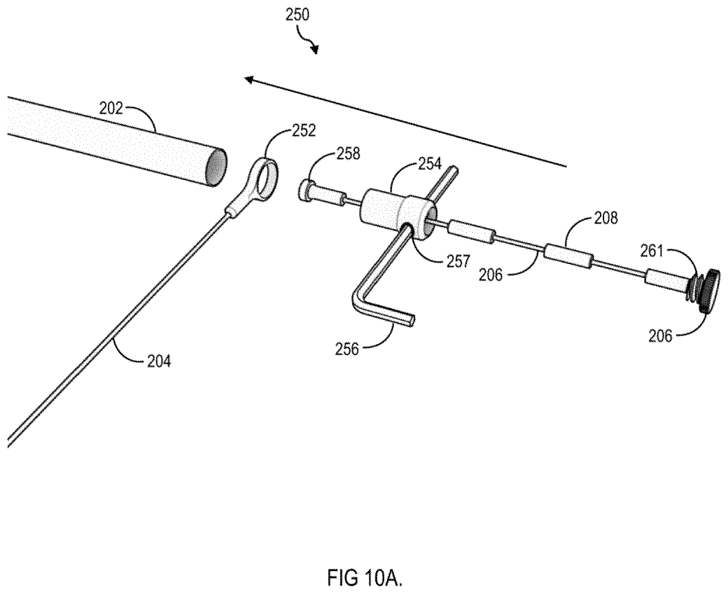

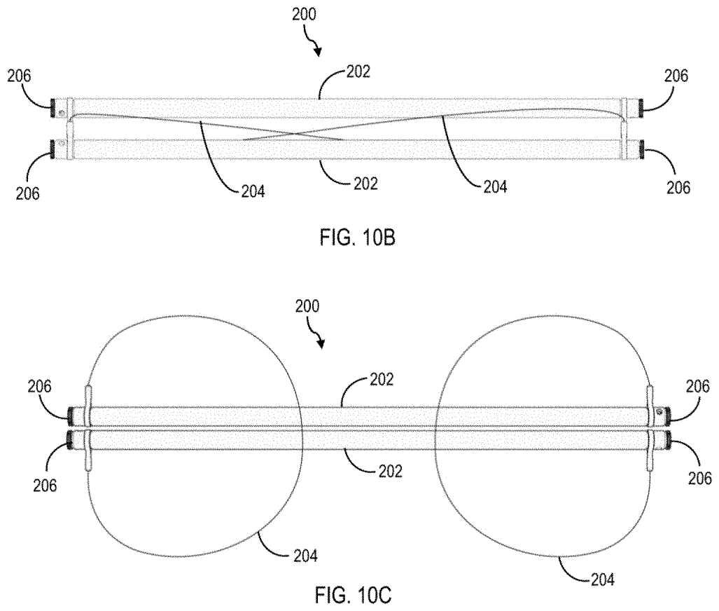

The frame 200 includes four corner projections 206 for removably attaching the frame 200 to a stand (FIGS. 5B-5C and 7A-7D). The corner projections 206 may be constructed of the same flexible metal wire as metal wires 204. According to an embodiment, the corner projections 206 may be withdrawn into the rails 206 when the frame 200 is collapsed (FIGS. 10A-10C).

The corner projections 206 includes a plurality of metal stoppers 208 (for ease of illustration only one stopper 208 is shown on each projection 206). The plurality of stoppers 208 are disposed on the projection 206 at increments corresponding to fixable heights of the stand attached to the frame, and consequently, fixable heights of the frame 200 above a heat source (FIGS. 7A-7D). The rails 202, wires 204 and corner projections 206 are preferably constructed of 304 stainless steel or hard anodized aluminum.

Referring to FIGS. 5B-5C, illustrated therein are perspective and top views, respectively, of the frame 200 shown in relation to a stand 300. The stand 300 may be the collapsible stand shown in Design U.S. Pat. No. 8,443,559S and described in PCT/CA2020/050631. The stand 300 includes four top corner joints 302 each having a groove for retaining the stoppers 208.

To removably attach the frame 200 to the stand 300, the corner projections 206 are inserted into the corner joints 302 such that the stoppers 208, are retained in the groove of each of the corner joints 302. Preferably, the same stopper 208 on each projection 206 is retained by the groove in each of the top corner joints 302 to maintain the frame 200 in planar configuration.

According to other embodiments (not shown) the cooking implements may themselves include corner projections 206 for attaching the cooking implement directly to the stand 300.

Referring to FIG. 6A, illustrated therein is a perspective view of a portable cooking apparatus 400, according to an embodiment. The portable cooking apparatus 400 includes the stand 300 attached to the frame 200. The portable cooking apparatus 400 includes at least one cooking implement (as shown, boiler pan 112) supported by the frame 200. The lip 112a of the boiler pan 112 rests on the rails 202 between the wires 204, thus retaining the boiler pan 112 between the rails 202 and wires 204. This is beneficial for using the stand 300 and frame 200 on uneven ground without having the boiler pan 112 slide off or out of the frame 200.

According to some embodiments wherein the wires 204 are elastic or spring-biased to pull the rails 202 together, the inward force of the rails 202 against the cooking implement (i.e. the boiler pan 112) provides increased stability and secure retaining of the cooking implement within the frame 200.

The boiler pan 112 may be moved along the rails 202 to any position between the wires 204. This is advantageous to allow the boiler pan 112 to be moved with respect to a heat source below the frame 200. For example, if the heat source is a fire, the frame 200 and stand 300 may be positioned partially over the fire so the boiler pan 112 is placed directly over the fire to boil water. Once the water is boiled, the boiling pan 112 may be easily slid along the rails 202 out of the direct flame, to keep the water simmering with indirect heat.

Similarly, other pans (i.e. the Hibachi pan 108 or the fry pan 110 in FIGS. 1A-2C) may be supported on the rails 202 and moved along the rails 202, with respect to a heat source, to vary temperature and cooking conditions. The pans 108, 110, 112 may also be moved along the rails to compensate for hot/cold spots in the heat source.

Referring to FIG. 6B, illustrated therein is a perspective view of a portable cooking apparatus 410, according to another embodiment. The portable cooking apparatus 410 includes the stand 300 attached to the frame 200. The frame 200 is large enough to support two cooking implements simultaneously (as shown, the Hibachi pan 108 and the fry pan 110). This allows for the separate cooking of different foods on different cooking surfaces at the same time, thereby preventing unwanted mixing of foods/liquids. For example, vegetarian items may be cooked on the fry pan 110 at the same time as meat items are cooked on the Hibachi pan 108. A further advantage is that for different cooking tasks may be performed simultaneously, for example, boiling water in one pan and heating oil on another pan.

According to another embodiments (not shown) a single large cooking implement, for example a griddle/hot plate, that occupies the entirely of the frame 200 between the rails 202 and wires 204 may be used.

Referring to FIG. 6C, illustrated therein is a side view of a portable cooking apparatus 420, according to another embodiment. The portable cooking apparatus 420 is substantially similar to the cooking apparatus 410, however, the boiler pan 112 is substituted for the Hibachi pan 108. From the side view, a further advantage of present invention can be seen. Given that the pans 110, 112 have different depths, the height at which food contained in the pans 110, 112 is above the heat source is different depending on the pan 110, 112 used. For example, food contained in the boiler pan 112 is closer to a heat source on the ground, than food on the Hibachi pan 108.

Thus, the same food, if cooked in the boiler pan 112 will cook faster than if cooked on the fry pan 110 (assuming the heat source produces uniform heat below both pans 110, 112). Thus, the different pans 110, 112 may be used akin to racks at different heights in a barbecue grill. Food may initially be cooked quickly in the boiler pan 112, then moved to the fry pan 110 to finish cooking/keep warm using the same heat source.

For increased versatility in varying the temperature, cooking conditions and cooking techniques, the height of the entire cooking apparatus 420 may be varied above a heat source by adjusting the height of the stand 300 (FIGS. 7A-7D).

Referring to FIG. 6D, illustrated therein is a perspective view of a portable cooking apparatus 430, according to an embodiment. The portable cooking apparatus 430 includes a portable fire pit 450 (i.e., a heat source). The fire pit 450 may be the portable fire pit described in PCT/CA2020/050631. The fire pit 450 includes top edges 452.

Cooking implements (as shown, Hibachi pan 108) may be directly supported on the top edges 452 of the fire pit 450. The lip 108a of the pan 108 rests on the top edges 452 of the fire pit 450 and the trough-portion of the pan 108 is retained between the top edges 452.

Now referring to FIGS. 7A-7C illustrated therein are perspective views showing height adjustment of the cooking apparatus 420. FIG. 7A shows the frame 200 and pans 110, 112 at a high height above a portable fire pit 450 (i.e., a heat source). The high height may be used, for example, cooking over a wood fire or high burning flame. To fix the stand 300 at the high height, the stoppers 208a (i.e., the stoppers closest to the rails 202) are inserted into the corner joints. Retaining of the stoppers 208a in the grooves of the corner joints 302 fixes the cooking surface frame 200 in the planar configuration and fixes the stand 300 at the high height.

FIG. 7B shows the frame 200 and pans 110, 112 at a medium height above the portable fire pit 450. The medium height may be used, for example, cooking over a charcoal or a low burning flame. To fix the stand 300 at the medium height, the stoppers 208b (i.e., the stoppers at an intermediate distance from the frame 200) are inserted into the grooves in the corner joints 302. Retaining of the stoppers 208b by the grooves fixes the frame 200 in the planar configuration and fixes the stand 300 at the medium height.

FIGS. 7C-7D shows the frame 200 and pans 110, 112 at a “low” height. The “low” height may be used to prop up the frame 200 such that the pans 110, 112 may be used at any height above the fire pit 450 depending on the props used. For example, rocks (represented by dashed lines) may be placed under the stand 300 to prop up the frame 200 (and pans 110, 112) and vary the height of the pans 110,112 above the flame. The use of larger rocks would raise the pans 110,112 to a higher height compared to the use of smaller rocks. Further, the low height may be used to deploy the stand 300 and frame 200 on uneven ground by using props of various sizes keep the pans 110, 112 level.

To fix the stand 300 at the low height, the stoppers 208c (i.e., the stoppers furthest from the rails 202) are inserted into the grooves of the corner joints 302. Retaining of the stoppers 208c by the grooves fixes the cooking surface frame 200 in the planar configuration and fixes the stand 300 at the low height.

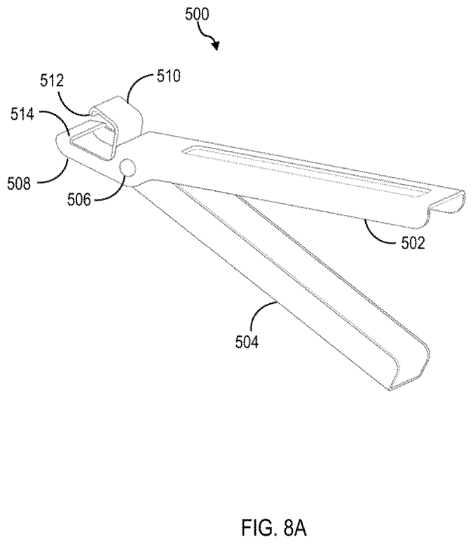

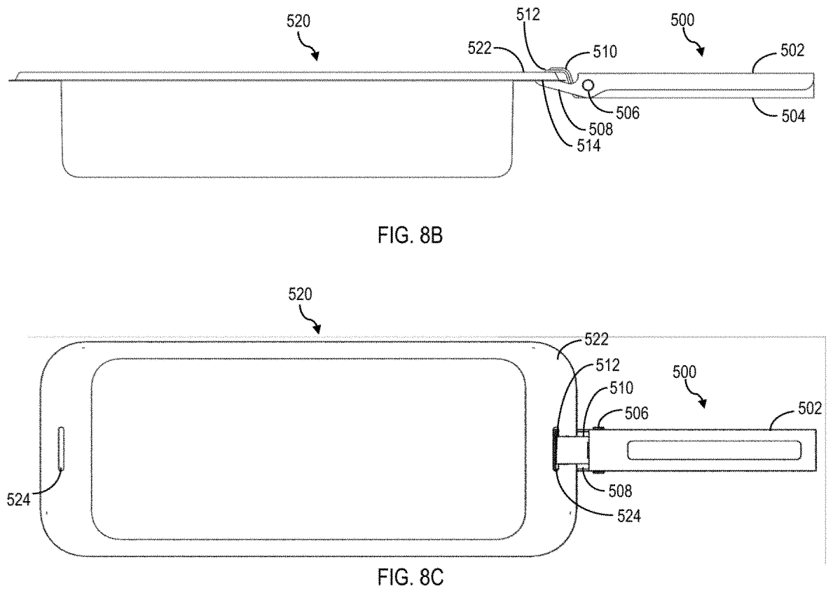

Referring to FIG. 8A-8C, shown therein is a grasping tool 500, according to an embodiment. The grasping tool 500 includes handles 502, 504 pivotably attached at a pivot point 506 to jaws 510, 512. The jaws 510, 512 may be manually opened and closed by separating and joining the handles 502, 504, respectively. The upper jaw 510 includes a tab 512. The lower jaw 508 includes a flat surface 514.

The grasping tool 500 may be used to grasp and move a cooking implement 520 (FIGS. 8B-8C). To grasp the cooking implement 520, the grasping tool is positioned so the tab 512 to insert into a slit 524 in a lip 522 of the cooking implement 520 and the handles 502, 504 are joined together such that the flat surface 514 contacts a bottom surface of the lip 522 when the handles 502, 504 are joined together. The flat surface 514 braces against the lip 522 to lift the cooking implement 520 and the tab 512 is retained within the slit 524 to ensure the cooking implement 520 does not slip from the grasping tool 500 until the handles 502, 504 are separated.

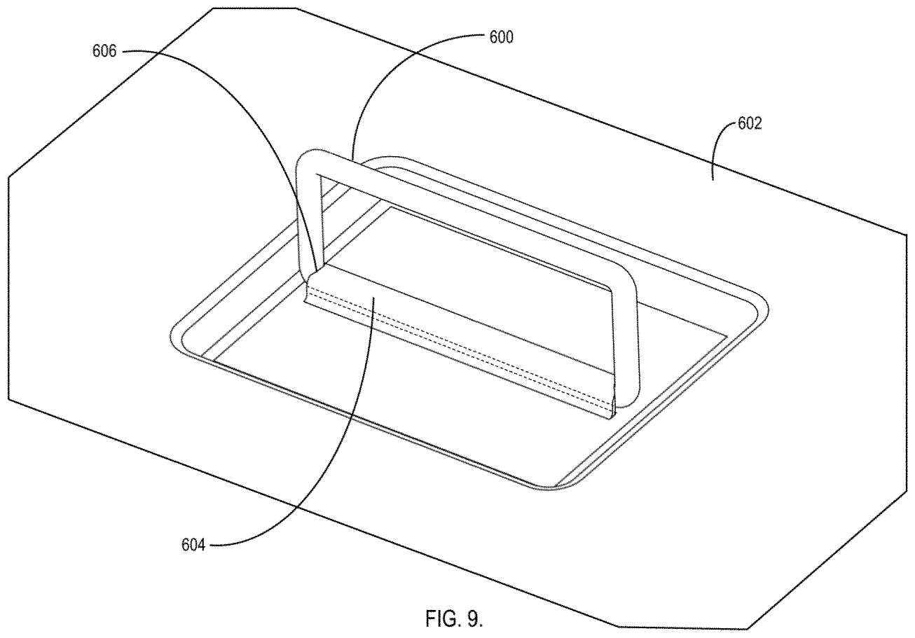

Referring to FIG. 9, shown therein is a handle 600 of a lid 602 according to an embodiment. The lid 602 may be the perforated lid 152 in FIGS. 2A-2D. The handle 600 may be manually raised to the upright position (as shown) or lowered to a horizontal position. The handle 600 is joined to the lid 602 by a stamped metal catch 604. The metal catch 604 includes arcuate indents 606 (one groove is shown) positioned on either end of the handle 600 to contact the section of the handle 600 passing through the catch 604 to hold the handle 600 unaided in the upright position (as shown).

Referring to FIG. 10A, shown therein is an exploded view of region 250 in FIG. 5A showing the rail 202, metal wire 204 and corner projection 206. The corner projection 206 and metal wire 204 are attached to the rail 202 by a fastener joint 254. The metal wire 204 includes a retaining loop 252 through which the fastener joint 254 passes to the attach the metal wire 204 to the rail 202. The fastener joint 254 may be loosened, for example using an Allen key 256 that passes through a hole 257, to disassemble the metal wire 204 and corner projection 206 from the rail 202 for maintenance and cleaning or storage. The fastener 254 joint may be tightened to attach the corner projection 206 and metal wire 204 to the rail 202. The fastener joint 254 and the interior of the rail 202 may be threaded to ensure a secure attachment of the metal wire 204 and corner projection 206 to the rail 202. For reference, the arrow points in the direction of attachment.

The corner projection 206 includes a retaining lug 528 to retain the corner projection 206 on the fastener joint 254 when attached to the rail 202. The retaining lug 528 also retains the fastener joint 254 on the corner projection 206 when detached from the rail 202 to prevent the fastener joint 254 from coming off the corner projection 206 and potentially being lost. The corner projection 206 further includes an end cap 260. The end cap 260 has threading 261 that mates with an interior threading of the fastener joint 254. The fastener joint 254 may traverse along the length of the corner projection 206 between the retaining lug 528 and the end cap 260. Accordingly, the threaded end cap 260 may be screwed into the fastener joint 254 to hold the withdrawn corner projection 206 within the rail 202 for transport/storage.

Referring to FIGS. 10B-10C, shown therein is the frame 200 of FIG. 5A in two collapsed configurations for storage/transport. FIG. 10B shows a “crossed” configuration wherein the corner projections 206 are withdrawn into the rails 202 and the rails 202 are rotated 180 degrees with respect to one another, thus causing the metal wires 204 to become crossed in an “X” shape. FIG. 10C shows a “figure 8” configuration wherein the corner projections 206 are withdrawn into the rails 202 and the rails 202 are joined together with the metal wires 204 forming a “Figure 8”.

While the above description provides examples of one or more apparatus, methods, or systems, it will be appreciated that other apparatus, methods, or systems may be within the scope of the claims as interpreted by one of skill in the art.

1. A portable cooking implement set comprising:
a first cooking implement having a first trough of a first depth and a first lip around the perimeter of the first trough and at least a first slit in the first lip; and
a second cooking implement having a second trough of a depth less than the first depth and a second lip around the perimeter of the second trough and at least a second slit in the second lip,
wherein the second cooking implement is placed atop the first cooking implement to securely retain at least a third cooking implement between the first cooking implement and the second cooking implement for transport/storage.

2. A portable cooking implement set of claim 1, wherein the at least third cooking implement has a third trough of a depth less than the first depth, a third lip around the perimeter of the third trough and at least a third slit in the third lip, wherein the third trough is nestable within the first trough when the third lip rests atop the first lip.

3. A portable cooking implement set of claim 1, wherein the at least third cooking implement comprises one or more of:
a fry pan, a hibachi pan and a bowl.

4. The portable cooking implement set of claim 1, wherein the second cooking implement is a perforated lid.

5. The portable cooking implement set of claim 1, wherein the first cooking implement is a boiling pan.

6. The portable cooking implement set of claim 1, wherein the first cooking implement, the second cooking implement and the at least third cooking implement are constructed of 304 stainless steel, anodized aluminum or carbon steel.

7. The portable cooking implement set of claim 1, wherein the first cooking implement, the second cooking implement and the at least third cooking implement further comprise corner projections for attaching each cooking implement to a stand.

8. The portable cooking implement set of claim 2, further comprising:
a grasping tool comprising:
a top jaw including a tab for inserting into any one of the first slit, the second slit and the third slit;
a bottom jaw including a flat surface for contacting any one of the first lip, the second lip and the third lip; and
a pair of handles connected to the top jaw and the bottom jaw at a pivot point, wherein separation of the handles causes a corresponding separation of the top jaw and the bottom jaw.

9. A portable frame for supporting cooking implements comprising:
a first rail and a second rail for supporting cooking implements, each rail having opposable ends;
a pair of flexible metal wires attaching the respective opposable ends of the first rail to the opposable ends of the second rail; and
four corner projections for removably attaching the portable frame to a stand, each corner projection extending from the opposable ends of each rail,
the portable frame being convertible from a compact configuration to a substantially planar configuration upon attachment to the stand, wherein the first rail and the second rail are parallel to each other and perpendicular to the metal wires.

10. The portable frame of claim 9, further comprising:
a brace for holding apart the first rail and the second rail, thereby straightening the metal wires to a maximum extent and bracing the portable frame in the planar configuration.

11. The portable frame of claim 9, wherein the metal wires and corner projections are elastic- or spring-biased to withdraw into the first rail and the second rail when in the compact configuration.

12. The portable frame of claim 9, wherein each corner projection includes one or more metal stoppers for inserting into joints on the stand to removably attach the portable frame to the stand.

13. The portable frame of claim 12, wherein the metal stoppers are disposed at increments along the length of each corner projection, the increments corresponding to fixable heights for the portable frame above a heat source.

14. The portable frame of claim 9, wherein in the planar configuration at least one cooking implement is supported by the first rail and the second rail and retained between the first rail, the second rail and the metal wires above a heat source.

15. The portable frame of claim 14, wherein the at least one cooking implement may be moved along a length of the rails, between the metal wires, to vary the position of the cooking implement with respect to the heat source.

16. The portable frame of claim 14, wherein the first rail and the second rail contact a lip of the at least one cooking implement.

17. The portable frame of claim 9, wherein the first rail, the second rail, the metal wires and the corner projections are constructed of 402 stainless steel or anodized aluminum.

18. The portable frame of claim 9 further comprising fastener joints for removably attaching the corner projections and metal wires to the opposable ends of the first rail and the second rail.

19. The portable frame of claim 18, wherein each metal wire comprises a pair of retaining loops through which the fastener joints passes to attach the metal wire to the first rail and the second rail.

20. The portable frame of claim 18, wherein the fastener joints are retained on the corner projections when detached from the first rail and the second rail.
